(19) United States
(12) Patent Application Publication
(10) Pub. No.: US 2009/0212519 A1
(43) Pub. Date: Aug. 27, 2009

(54) SWING STRUCTURE FOR A KICK SCOOTER

(75) Inventors: TING-HSING CHEN, TAINAN HSIEN (TW); YONG-RAK KIM, JIANGSU PROVINCE (CN)

Correspondence Address: ROSENBERG, KLEIN & LEE, 3458 ELLICOTT CENTER DRIVE-SUITE 101, ELLICOTT CITY, MD, 21043, US

(73) Assignee: C&H HK CORP. LTD., KOWLOON (HK)

(21) Appl. No.: 12/036,463

(22) Filed: Feb. 25, 2008

(51) Int. Cl. B62M 1/00

(52) U.S. Cl. 280/87.01

(57) ABSTRACT

A swing structure for a kick scooter includes a center tube, an axle pipe, a first bushing pad, a second bushing pad and a cap. The center tube comprises a pair of ring plates spaced from each other and a protuberance. The axle pipe is provided with a bracket. The first bushing pad is disposed on the bracket and located between the two ring plates of the center tube. The first bushing pad has a restricting slot for insertion of the protuberance of the center tube. The second bushing pad is coupled to the first bushing pad. The cap covers the second bushing pad and is secured to the bracket by means of fasteners.

### BACKGROUND OF THE INVENTION

1. Field of the Invention

The present invention relates to a swing structure for a kick scooter, in particular a bracket of an axle pipe is provided with a first bushing pad having a restricting slot to restrict the turning angle of a center tube.

2. Description of the Prior Art

A conventional kick scooter currently on the market has a structure of twin front wheels and twin rear wheels. When the kick scooter makes turns, if the user makes wider turning angle, the outer wheels of the front and the rear of the structure will be lifted due to the centrifugal force, hence the kick scooter tends to flip over and hurt the rider.

Due to the above shortcoming, a new design is developed as the U.S. Pat. No. 7,303,199 which provides stability to the wheels. This design comprises a center tube and an axle pipe. The center tube is provided with round plates and flanges at a rear section thereof. The axle pipe comprises a curved receiving base having slots. The round plates are inserted through the slots. The center tube is rotatable with respect to the axle pipe. In this design, the flanges strike an arcuate board next to the slots at right angle, which may cause cracks on the slots.

### SUMMARY OF THE INVENTION

A swing structure for a kick scooter provides not only a safety feature but also a solid structure, preventing the wheels of the kick scooter from lifting up when the user makes turns.

According to the present invention, there is provided a swing structure for a kick scooter comprising a center tube comprising a pair of ring plates spaced from each other and a protuberance; an axle pipe comprising a bracket thereon; a first bushing pad seating on said bracket and being located between said ring plates of said center tube, said first bushing pad having a restricting slot for insertion of said protuberance of said center tube; a second bushing pad corresponding to said first bushing pad; and a cap wrapping said second bushing pad and being secured to said bracket of said axle pipe by fasteners.

The first bushing pad and the second bushing pad are formed in a semicircular shape so as to wrap the center tube in a rotatable manner. The second bushing pad may be provided with a restricting slot to restrict the turning angle of the center tube.

It is the primary object of the present invention to provide a swing structure for a kick scooter, which can run smoothly.

It is another object of the present invention to provide a swing structure for a kick scooter, which can run safely.

It is a further object of the present invention to provide a swing structure for a kick scooter, which is more durable.

It is still a further object of the present invention to provide a swing structure for a kick scooter, which provides a first bushing pad and a second bushing pad that are exchangeable.

### BRIEF DESCRIPTION OF THE DRAWINGS

FIG. 1 is a perspective view of the present invention;

FIG. 2 is an exploded view of the present invention;

FIG. 3 is a cross-sectional view taken along the axis of a center tube of the present invention;

FIG. 4 is a cross-sectional view taken along line A-A of FIG. 3; and

FIG. 5 is a cross-sectional view taken along line B-B of FIG. 3;

### DETAILED DESCRIPTION OF THE PREFERRED EMBODIMENT

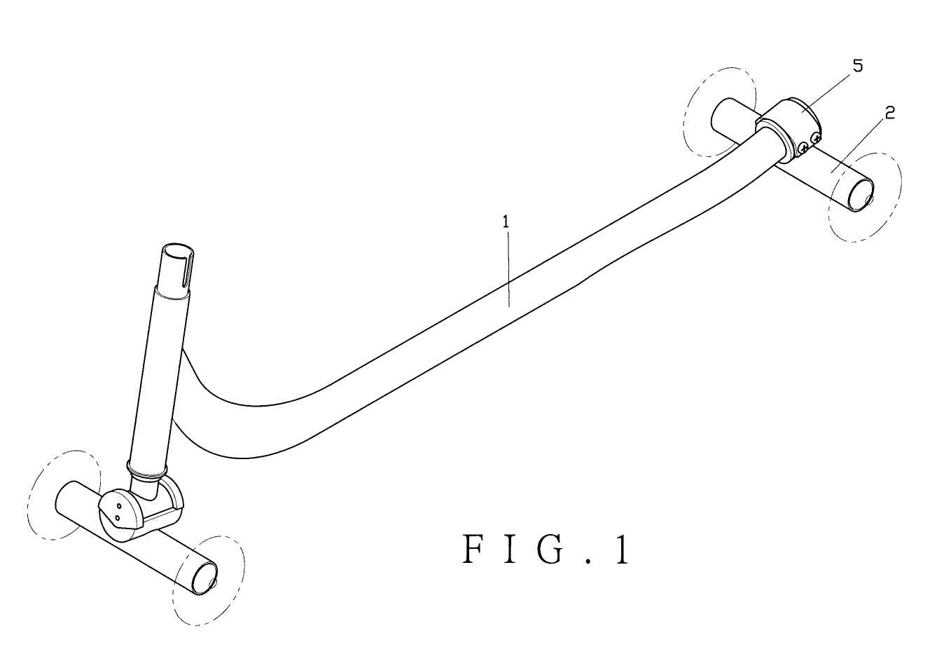

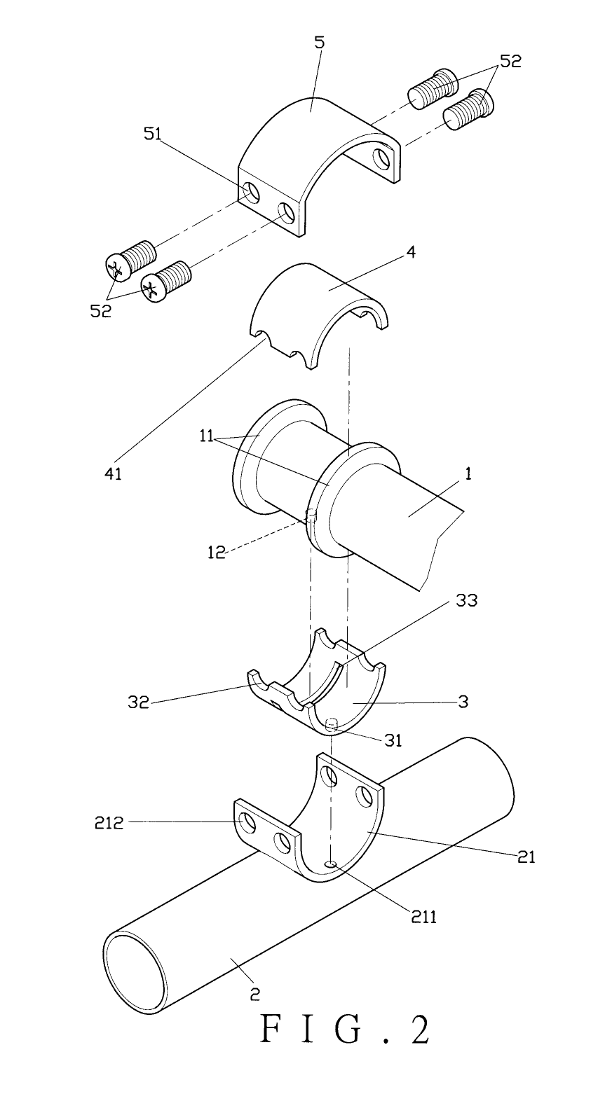

As shown in FIGS. 1 and 2, a preferred embodiment of the present invention comprises a center tube 1, an axle pipe 2, a first bushing pad 3, a second bushing pad 4 and a cap 5.

As shown in FIGS. 2 thru 4, the center tube 1 comprises a pair of ring plates 11 spaced from each other and a protuberance 12.

The axle pipe 2 comprises an arc-shaped bracket 21 thereon. The bracket 21 has a hole 211 at the bottom of the bracket 21 and a plurality of through holes 212 thereon.

The first bushing pad 3 is in a semicircular shape, and comprises a protruding lug 31, arcuate troughs 32 and a restricting slot 33. The protruding lug 31 is inserted and secured in the hole 211 of the bracket 21.

The second bushing pad 4 has arcuate troughs 41, and is in a semicircular shape corresponding to the first bushing pad 3 to wrap the center tube 1 in a rotatable manner. The first bushing pad 3 and the second bushing pad 4 may have the same structure for exchangeable purpose. The arcuate troughs 32 and 41 are assembled to form through holes.

The cap 5 is in an arcuate shape with two sides extending downward. The two sides are formed with through holes 51 for insertion of fasteners 52. The fasteners 52 may be bolts.

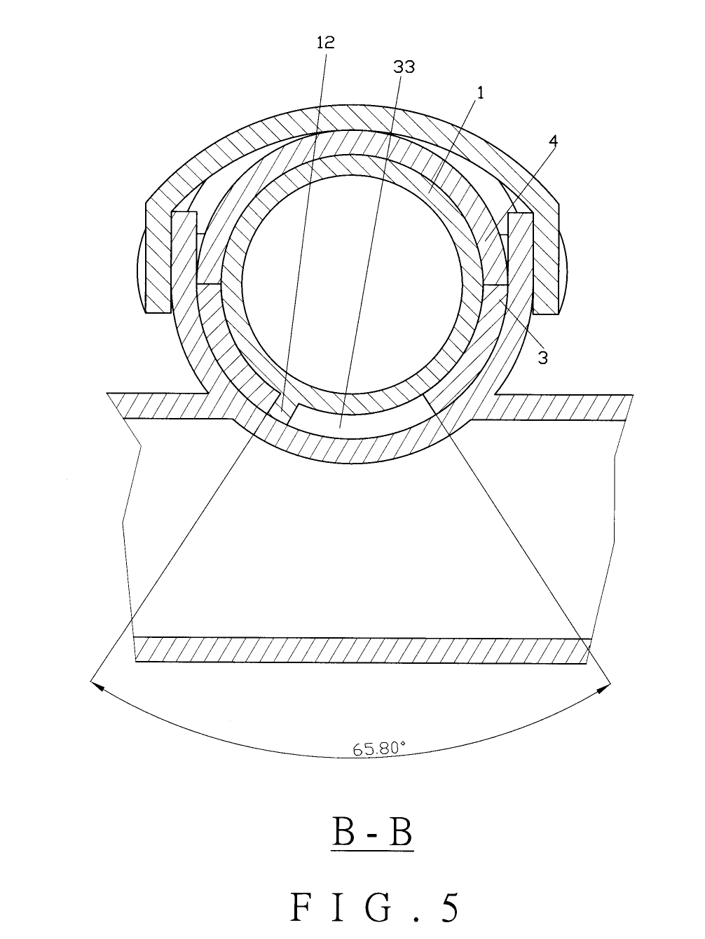

The restricting slot 33 is in an arcuate shape at a predetermined angle to restrict the turning angle of the center tube 1, as shown in FIG. 5.

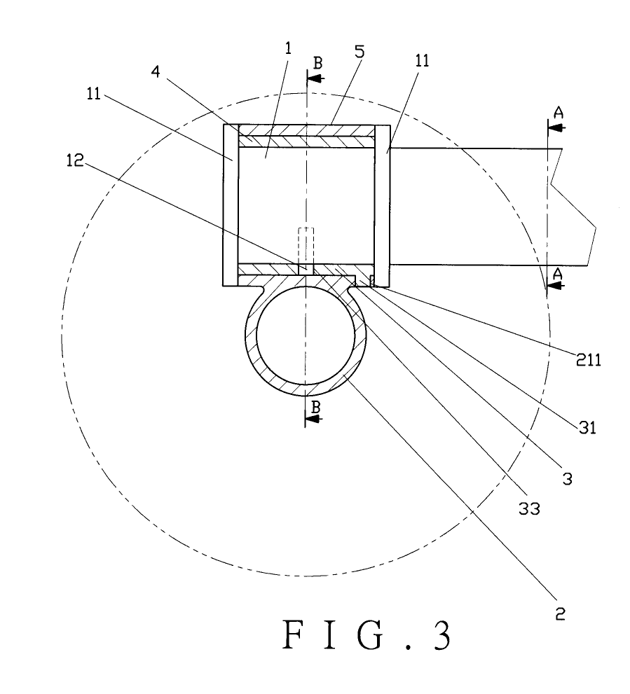

FIG. 3 is an assembled view of the present invention. The first bushing pad 3 wraps the lower half portion of the center tube 1 and seats on the bracket 21, while the second bushing pad 4 wraps the upper half portion of the center tube 1 and is coupled to the first bushing pad 3. The cap 5 is adapted to cover the second bushing pad 4 and secured to the bracket 21 of the axle pipe 2 with the fasteners 52 inserting through the through holes 51 and 212.

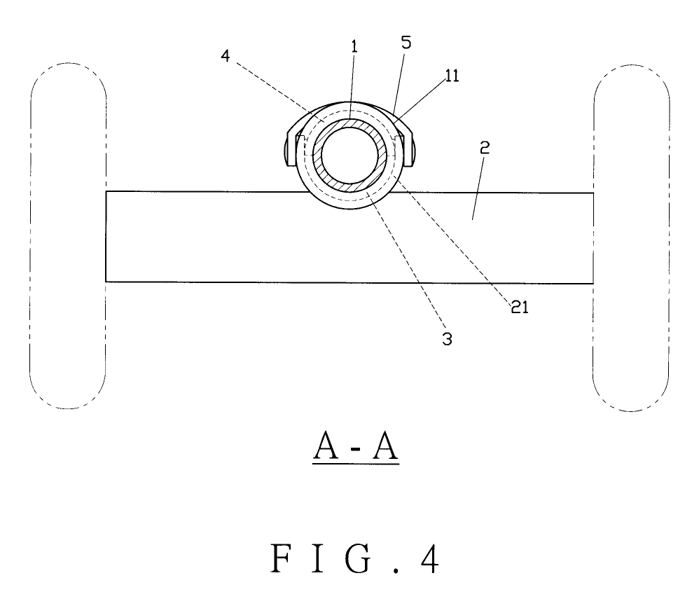

As shown in FIG. 4, the bracket 21 with the first bushing pad 3 is located between the two ring plates 11 of the center tube 1, and the protuberance 12 of the center tube 1 is inserted into the restricting slot 33 of the first bushing pad 3, allowing the center tube 1 to be able to turn at a certain angle. The second bushing pad 4 corresponds to the first bushing pad 3, while the cap 5 encloses the second bushing pad 4 and is secured with the fasteners 52 to the bracket 21.

The turning angle of the center tube 1, as shown in FIG. 5, is restricted by the protuberance 12 within the restricting slot 33.

In this embodiment, the above-mentioned swing structure is to be used as the rear wheel set of a kick scooter, a similar structure for the front wheel set of a kick scooter may be appropriated.

I claim:

1. A swing structure for a kick scooter, comprising:
a center tube comprising a pair of ring plates spaced from each other and a protuberance;
an axle pipe comprising a bracket thereon;
a first bushing pad seating on said bracket and being located between said ring plates of said center tube, said first bushing pad having a restricting slot for insertion of said protuberance of said center tube;
a second bushing pad corresponding to said first bushing pad; and
a cap wrapping said second bushing pad and being secured to said bracket of said axle pipe by fasteners.

2. The swing structure for a kick scooter, as recited in claim 1, wherein said restricting slot is in an arcuate shape.

3. The swing structure for a kick scooter, as recited in claim 1, wherein said second bushing pad has a restricting slot.
